(19) United States
(12) Patent Application Publication
(10) Pub. No.: US 2026/0014049 A1
(43) Pub. Date: Jan. 15, 2026

(54) Cosmetic Instrument

(71) Applicant: Xiamen Ubest Electronic Technology Co., Ltd., Xiamen (CN)

(72) Inventor: Zonghu Zhu, Xiamen (CN)

(21) Appl. No.: 18/789,784

(22) Filed: Jul. 31, 2024

(30) Foreign Application Priority Data
Jul. 9, 2024 (CN) 202421610270.X

(51) Int. Cl. A61H 23/02

(52) U.S. Cl. CPC A61H 23/02; A61H 2201/0119; A61H 2201/025; A61H 2205/022

(57) ABSTRACT

Disclosed is a cosmetic instrument, including a massage head, a host machine and a fan, wherein the massage head is detachably connected to the host machine, a first air channel and a second air channel are provided in the massage head, one ends of the first air channel and the second air channel are in communication with outside, and the other ends of the first air channel and the second air channel are provided at a connection between the massage head and the host machine; and the fan is provided in the second air channel; the detachable design of the massage head and the host machine can expand the functionality of the massage head and can conveniently use massage heads with different functions alternatively; and, on the other hand, the application can ensure the heat dissipation functions of the massage head and the host machine and reduce the weight thereof.

### CROSS-REFERENCE TO RELATED APPLICATIONS

The present application claims priority to Chinese Patent Application No. 202421610270.X, filed on July 9, 2024, the entire contents of which are incorporated herein by reference.

### TECHNICAL FIELD

The present disclosure relates to the field of cosmetic care devices, and more particularly to a cosmetic instrument.

### BACKGROUND

Current cosmetic instruments generally include a massage head having a specific function and a host machine connected to the massage head and provided with a battery and a control circuit. In the use of the massage head, for example, a structure with a cold-hot regulating function is used, and since the design of a cold-hot semiconductor requires sufficient active heat dissipation, corresponding air channel(s) and fan(s) are arranged on the device. The general arrangement forms are as follows: one is to arrange an air channel and a fan on the host machine, and the cold-hot semiconductor at the massage head contacts and performs heat exchange with the air channel in the host machine via a thermal conductivity structure, and such a structure cannot perform heat exchange in time to dissipate heat of the massage head due to the existence of a certain distance between the host machine and the massage head, with a poor use effect; the other is to arrange an air channel and a fan on the massage head, and although this design can well dissipate heat at the massage head, the arrangement of the air channel and the fan requires a certain space, resulting in a mass of the massage head, increased weight and inconvenience of replacement, which also brings about certain disadvantages.

### SUMMARY

The technical problem to be solved by the present disclosure is to provide a cosmetic instrument that provides good heat dissipation and also facilitates massage head replacement.

In order to solve the above-mentioned technical problem, the technical solution adopted by the present disclosure is a cosmetic instrument, including a massage head, a host machine and a fan, wherein the massage head is detachably connected to the host machine, a first air channel is provided in the massage head, one end of the first air channel is in communication with outside, and the other end of the first air channel is provided at a connection between the massage head and the host machine; a second air channel is provided in the host machine, one end of the second air channel is in communication with the outside, and the other end of the second air channel is provided at a connection between the host machine and the massage head; and the fan is provided in the second air channel.

Further, one end, communicating with the outside, of the first air channel is provided at a side face of the massage head.

Further, one end, communicating with the outside, of the first air channel is a first air port disposed around a side face of the massage head.

Further, one end, communicating with the outside, of the second air channel is provided at a side face of the host machine.

Further, one end, communicating with the outside, of the second air channel is provided at an end, remote from the massage head, of the host machine.

Further, one end of the massage head is provided with a docking seat, one end of the host machine is provided with a docking groove, and the docking seat is inserted into the docking groove; and one end of the first air channel is provided on the docking seat, and one end of the second air channel is provided in the docking groove.

Further, a filter screen structure is provided at a groove bottom of the docking groove.

Further, the massage head is a micro-current refrigerating massage head provided with a micro-current output device and a cold-hot semiconductor.

Further, a heat dissipation blade is provided in the first air channel of the massage head.

Further, a battery assembly is provided in the host machine, a first connection end is provided on the massage head, a second connection end is provided on the host machine, and the second connection end is connected to the battery assembly; and the first connection end is detachably connected to the second connection end.

The beneficial effects of the present disclosure are that cosmetic care is given to the required part through the massage head, and the part of the host machine is used as a holding structure; the detachable design of the massage head and the host machine can, on the one hand, expand the functionality of the massage head and can conveniently use massage heads with different functions alternatively; and, on the other hand, the detachable design of the massage head, the arrangement of the first air channel, the second air channel in the host machine, and the arrangement of the fan can ensure the heat dissipation functions of the massage head and the host machine and reduce the weight thereof.

### BRIEF DESCRIPTION OF THE DRAWINGS

FIG. 1 is a side view diagram of a cosmetic instrument of a detailed implementation of the present disclosure.

FIG. 2 is a schematic structural diagram of the cosmetic instrument of a detailed implementation of the present disclosure when a massage head is separated from a host machine.

FIG. 3 is a schematic structural diagram of a first air channel and a second air channel of the cosmetic instrument of a detailed implementation of the present disclosure when a second air port is provided at an end of the host machine.

FIG. 4 is a schematic structural diagram of the first air channel and the second air channel of the cosmetic instrument of a detailed implementation of the present disclosure when the second air port is provided at a side face of the host machine.

FIG. 5 is a schematic structural diagram of the massage head with a cold-hot regulating function of the cosmetic instrument of a detailed implementation of the present disclosure.

FIG. 6 is a schematic structural diagram of the massage head with an LED of the cosmetic instrument of a detailed implementation of the present disclosure.

### DETAILED DESCRIPTION OF THE EMBODIMENTS

In order to explain the technical contents, the achieved objects and the effects of the present disclosure in detail, the following description is made in conjunction with the implementations and the accompanying drawings.

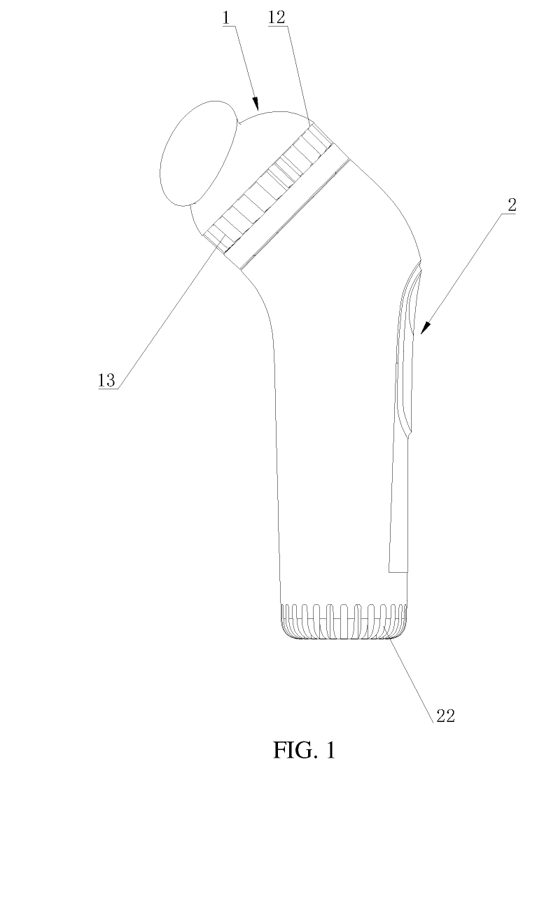

With reference to FIGS. 1 to 6, provided is a cosmetic instrument, including a massage head 1, a host machine 2 and a fan 3, wherein the massage head 1 is detachably connected to the host machine 2, a first air channel 11 is provided in the massage head 1, one end of the first air channel 11 is in communication with outside, and the other end of the first air channel 11 is provided at a connection between the massage head 1 and the host machine 2; a second air channel 21 is provided in the host machine 2, one end of the second air channel 21 is in communication with the outside, and the other end of the second air channel 21 is provided at a connection between the host machine 2 and the massage head 1; and the fan 3 is provided in the second air channel 21.

It can be seen from the foregoing description that the beneficial effects of the present disclosure are that cosmetic care is given to the required part through the massage head 1, and the host machine 2 is used as a holding structure; the detachable design of the massage head 1 and the host machine 2 can, on the one hand, expand the functionality of the massage head 1 and can conveniently use massage heads 1 with different functions alternatively; and, on the other hand, the detachable design of the massage head 1, the arrangement of the first air channel 11, the second air channel 21 in the host machine 2, and the arrangement of the fan 3 can ensure the heat dissipation functions of the massage head 1 and the host machine 2 and reduce the weight thereof.

Further, one end, communicating with the outside, of the first air channel 11 is provided at a side face of the massage head 1.

It can be seen from the foregoing description that the air enters or exits the first air channel 11 through the side face of the massage head 1.

Further, one end, communicating with the outside, of the first air channel 11 is a first air port 12 disposed around a side face of the massage head 1.

It can be seen from the foregoing description that the arrangement of the first air port 12 around the side face of the massage head 1 can ensure that there is a sufficient air passing area, and ensure that the first air channel 11 and the second air channel 21 are dissipated by a sufficient air flow ventilation.

Further, one end, communicating with the outside, of the second air channel 21 is provided at a side face of the host machine 2.

It can be seen from the foregoing description that the air enters or exits the second air channel 21 through the side face of the host machine 2.

Further, one end, communicating with the outside, of the second air channel is provided at an end, remote from the massage head 1, of the host machine 2.

It can be seen from the foregoing description that the air enters or exits the second air channel 21 through the end of the host machine 2. The second air channel 21 may extend through the entire host machine 2 so that it can simultaneously dissipates heat from the components such as a circuit board, a battery, etc. in the host machine 2.

Further, one end of the massage head 1 is provided with a docking seat 14, one end of the host machine 2 is provided with a docking groove 23, and the docking seat 14 is inserted into the docking groove 23; and one end of the first air channel 11 is provided on the docking seat 14, and one end of the second air channel 21 is provided in the docking groove 23.

It can be seen from the foregoing description that the positioning connection between the massage head 1 and the host machine 2 and the docking of the two air channels are achieved by the cooperation of the docking seat 14 and the docking groove 23.

Further, a filter screen structure 24 is provided at a groove bottom of the docking groove 23.

It can be seen from the foregoing description that the air entering the second air channel 21 can be filtered by the design of the filter screen structure 24.

Further, the massage head 1 is a micro-current refrigerating massage head 1 provided with a micro-current output device and a cold-hot semiconductor.

It can be seen from the foregoing description that the micro-current refrigerating massage head 1 can be used, and through the co-action of the micro-current output device and the cold-hot semiconductor, can play the role of cold compress and reducing tingling sensation through the cold-hot semiconductor during current nursing.

Further, a heat dissipation blade 13 is provided in the first air channel 11 of the massage head 1.

It can be seen from the foregoing description that the heat dissipation efficiency of the massage head 1 is further improved by the design of the heat dissipation blade(s) 13.

Further, a battery assembly is provided in the host machine 2, a first connection end is provided on the massage head 1, a second connection end is provided on the host machine 2, and the second connection end is connected to the battery assembly; and the first connection end is detachably connected to the second connection end.

It can be seen from the foregoing description that through the connection between the first connection end on the massage head 1 and the second connection end of the host machine 2, the massage head 1 after mounting can be electrically connected with the battery assembly in the host machine 2 to ensure the supply of electric energy.

### Example I:

Application scenario: in the use of the massage head 1, for example, a structure with a cold-hot regulating function is used, and since the design of a cold-hot semiconductor requires sufficient active heat dissipation, corresponding air channel(s) and fan(s) 3 are arranged on the device. The general arrangement forms are as follows: one is to arrange an air channel and a fan 3 on the host machine 2, and the cold-hot semiconductor at the massage head 1 contacts and performs heat exchange with the air channel in the host machine 2 via a thermal conductivity structure, and such a structure cannot perform heat exchange in time to dissipate heat of the massage head 1 due to the existence of a certain distance between the host machine 2 and the massage head 1, with a poor use effect; the other is to arrange an air channel and a fan 3 on the massage head 1, and although this design can well dissipate heat at the massage head 1, the arrangement of the air channel and the fan 3 requires a certain space, resulting in a mass of the massage head 1, increased weight and inconvenience of replacement, which also brings about certain disadvantages.

As shown in FIGS. 1, 2 and 4, the cosmetic instrument of Example I includes a massage head 1, a host machine 2 and a fan 3, wherein the massage head 1 is detachably connected to the host machine 2, a first air channel 11 is provided in the massage head 1, one end of the first air channel 11 is in communication with outside, and the other end of the first air channel 11 is provided at a connection between the massage head 1 and the host machine 2; a second air channel 21 is provided in the host machine 2, one end of the second air channel 21 is in communication with the outside, and the other end of the second air channel 21 is provided at a connection between the host machine 2 and the massage head 1; and the fan 3 is provided in the second air channel 21.

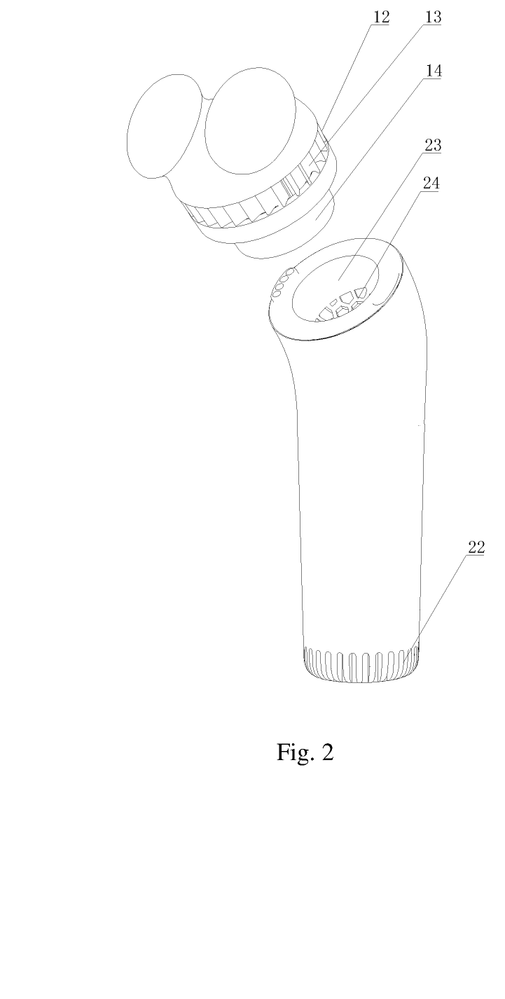

As shown in FIG. 2, specifically, one end of the massage head 1 is provided with a docking seat 14, one end of the host machine 2 is provided with a docking groove 23, and the docking seat 14 is inserted into the docking groove 23; filter screen structure 24 is provided at a groove bottom of the docking groove 23; and one end of the first air channel 11 is provided on the docking seat 14, and one end of the second air channel 21 is provided in the docking groove 23. In order to further ensure the stability of the connection between the docking seat 14 and the docking groove 23, a magnetic element is provided on both the docking seat 14 and the docking groove 23 so as to make the two closely fit in a magnetic attraction manner.

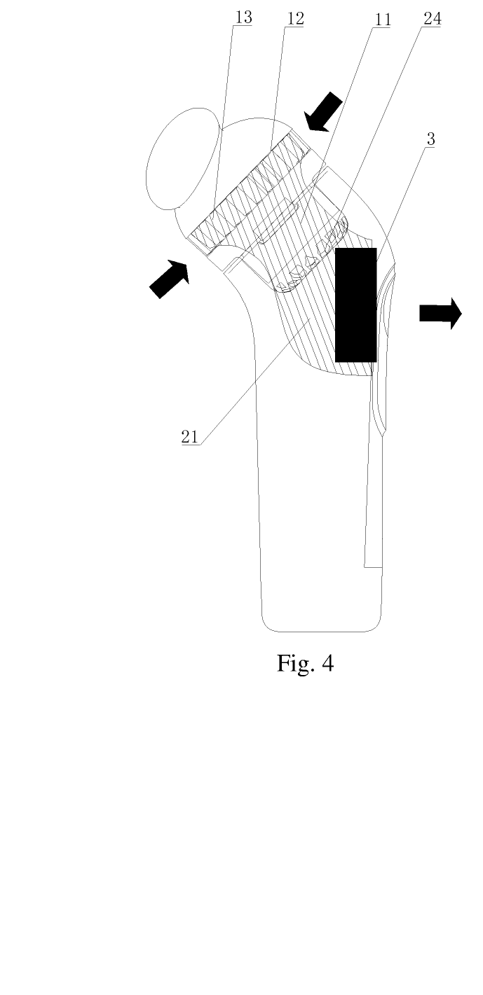

As shown in FIG. 4, one end, communicating with the outside, of the first air channel 11 is a first air port 12 disposed around a side face of the massage head 1; one end, communicating with the outside, of the second air channel 21 is provided on a side face of the host machine 2, and one end, communicating with the outside, of the second air channel 21 is provided on a back side of the host machine 2 in Example I, and correspondingly, the fan 3 is also provided in the first air channel 11 of the host machine 2 near the back side of the host machine 2.

A battery assembly is provided in the host machine 2, a first connection end is provided on the massage head 1, a second connection end is provided on the host machine 2, and the second connection end is connected to the battery assembly; and the first connection end is detachably connected to the second connection end. Specifically, the first connection end on the massage head 1 is a connection groove provided on the docking seat 14 and having a contact, and a second connection end on the host machine 2 is a connection block provided on the docking groove 23 and having a contact. While the docking seat 14 of the massage head 1 is plugged into the docking groove 23 of the host machine 2, the connection groove and the connection block cooperate with each other, and contact connection between the two is fixed.

Working principle: taking the first air port 12 of the massage head 1 as an air inlet as an example, during use, air can be actively drawn by the internal fan 3 to reduce the temperature. The air is sufficiently drawn from the first air port 12 arranged circumferentially on the massage head 1 into the first air channel 11, and the heat at the massage head 1 is carried away, and then the air flows into the second air channel 21, and heat exchange is performed with the internal components of the host machine, and heat is finally discharged from the second air port 22 on the back side of the host machine. The second air port 22 of the host machine may also be used as an air inlet according to actual design requirements.

The above-mentioned design of the first air channel 11 and the second air channel 21 can ensure heat dissipation at the massage head 1 well, and at the same time, the massage head 1 can be detachably arranged in accordance with a detachable and replaceable design.

### Example II:

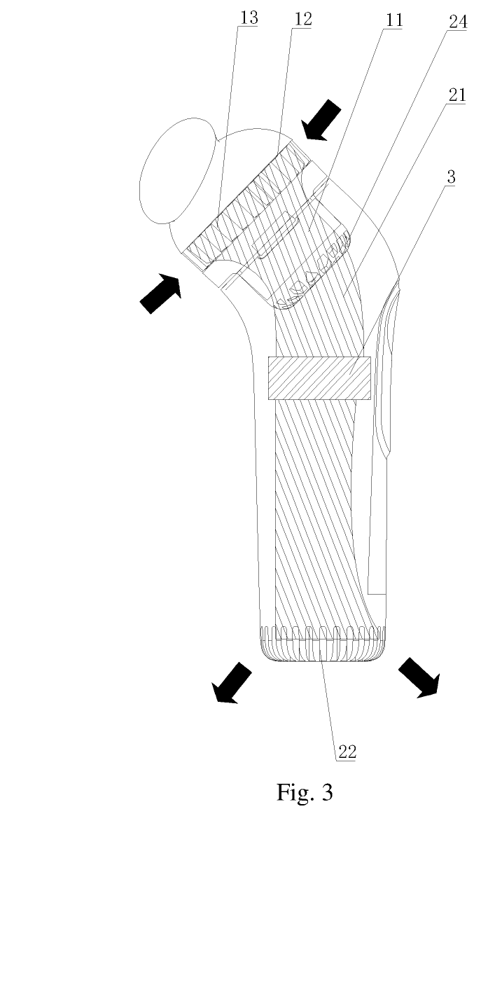

The difference between Example II and Example I is that, as shown in FIG. 3, one end, communicating with the outside, of the second air channel is provided at an end, remote from the massage head 1, of the host machine 2.

### Example III:

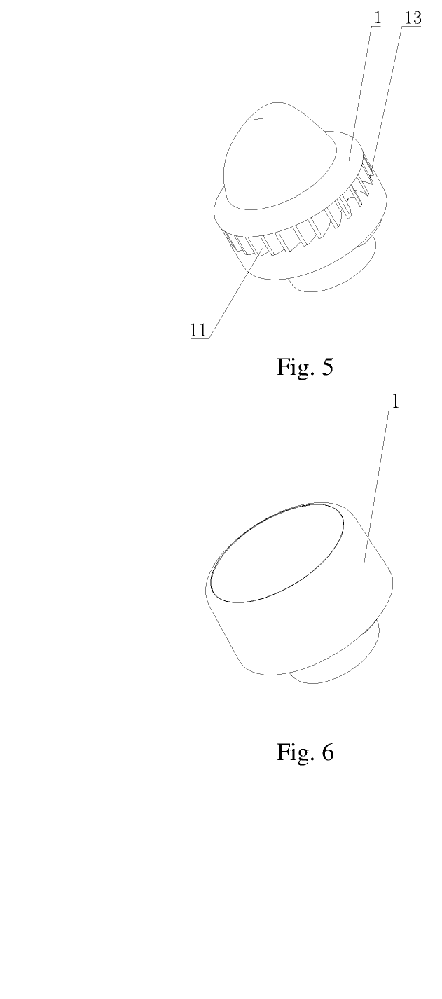

The difference between Example III and Example I is that, as shown in FIGS. 1-4, the massage head 1 is a micro-current refrigerating massage head 1 provided with a micro-current output device and a cold-hot semiconductor; specifically, the micro-current refrigerating massage head 1 generally has two contacts, respectively corresponding to a positive pole and a negative pole of the micro-current output device. Accordingly, a heat dissipation blade 13 is provided in the first air channel 11 on the massage head 1. In addition, according to the function of the massage head 1, the massage head 1 with cold-hot regulating function as shown in FIG. 5, the massage head 1 with an LED as shown in FIG. 6, and the massage head 1 with heating and vibration cleaning function can be selected, wherein the massage head 1 with cold-hot regulating function and the massage head 1 with the same type of function both achieve temperature regulation by means of a cold-hot semiconductor, and thus a heat dissipation blade 13 needs to be designed for heat dissipation, while other massage heads 1 without a cold-hot semiconductor can be designed without the heat dissipation blade 13.

In summary, in the cosmetic instrument provided in the present disclosure, cosmetic care is given to the required part through the massage head, and the part of the host machine is used as a holding structure; the detachable design of the massage head and the host machine can, on the one hand, expand the functionality of the massage head and can conveniently use massage heads with different functions alternatively; and, on the other hand, the detachable design of the massage head, the arrangement of the first air channel, the second air channel in the host machine, and the arrangement of the fan can ensure the heat dissipation functions of the massage head and the host machine and reduce the weight thereof.

The foregoing description is merely an example of the present disclosure, and does not limit the scope of patent of the present disclosure. Any equivalent transformation made by using the contents of the description and the drawings of the present disclosure or directly or indirectly used in the relevant technical field is likewise included in the scope of the patent protection of the present disclosure.

What is claimed is:

1. A cosmetic instrument, comprising a massage head, a host machine and a fan, wherein the massage head is detachably connected to the host machine, a first air channel is provided in the massage head, one end of the first air channel is in communication with outside, and the other end of the first air channel is provided at a connection between the massage head and the host machine; a second air channel is provided in the host machine, one end of the second air channel is in communication with the outside, and the other end of the second air channel is provided at a connection between the host machine and the massage head; and the fan is provided in the second air channel.

2. The cosmetic instrument according to claim 1, wherein one end, communicating with the outside, of the first air channel is provided at a side face of the massage head.

3. The cosmetic instrument according to claim 2, wherein one end, communicating with the outside, of the first air channel is a first air port disposed around a side face of the massage head.

4. The cosmetic instrument according to claim 1, wherein one end, communicating with the outside, of the second air channel is provided at a side face of the host machine.

5. The cosmetic instrument according to claim 4, wherein one end, communicating with the outside, of the second air channel is provided at an end, remote from the massage head, of the host machine.

6. The cosmetic instrument according to claim 1, wherein one end of the massage head is provided with a docking seat, one end of the host machine is provided with a docking groove, and the docking seat is inserted into the docking groove; and one end of the first air channel is provided on the docking seat, and one end of the second air channel is provided in the docking groove.

7. The cosmetic instrument according to claim 6, wherein a filter screen structure is provided at a groove bottom of the docking groove.

8. The cosmetic instrument according to claim 1, wherein the massage head is a micro-current refrigerating massage head provided with a micro-current output device and a cold-hot semiconductor.

9. The cosmetic instrument according to claim 1, wherein a heat dissipation blade is provided in the first air channel of the massage head.

10. The cosmetic instrument according to claim 1, wherein a battery assembly is provided in the host machine, a first connection end is provided on the massage head, a second connection end is provided on the host machine, and the second connection end is connected to the battery assembly; and the first connection end is detachably connected to the second connection end.
